(19) United States
(12) Patent Application Publication
(10) Pub. No.: US 2026/0225658 A1
(43) Pub. Date: Aug. 6, 2026

(54) ADJUSTABLE WHEELBASE SYSTEM

(71) Applicant: GM GLOBAL TECHNOLOGY OPERATION LLC, Detroit, MI (US)

(72) Inventor: Garrick C. Zack, Troy, MI (US)

(21) Appl. No.: 19/043,778

(22) Filed: Feb. 3, 2025

(51) Int. Cl. B62D 21/14; B60K 1/02; B60K 1/04; B60K 7/00; B60K 17/04; B60L 50/60; B62D 59/04

(52) U.S. Cl. CPC B62D 21/14; B60K 1/02; B60K 1/04; B60K 7/0007; B60K 17/043; B60L 50/60; B62D 59/04; B60K 2001/0411; B60K 2001/0416; B60L 2200/28

(57) ABSTRACT

An adjustable wheelbase system including: guide tracks configured to be mounted to a vehicle; a front support assembly configured to be attached to, and move along, the guide tracks; a front motor system mounted to the front support assembly and configured to rotate front wheels of the vehicle; a rear support assembly configured to be attached to, and move along, the guide tracks; a rear motor system mounted to the rear support assembly and configured to rotate rear wheels of the vehicle; a battery system configured to power the front motor system and the rear motor system; and a controller.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to an adjustable wheelbase system.

A wheelbase is generally the horizontal distance between centers of front wheels and rear wheels, such as of road vehicles, rail cars, etc. Road vehicles with wheelbases include trailers configured to be towed by a car or truck. Some trailers include a tandem axle with a relatively small wheelbase, while other trailers include a relatively larger wheelbase with the front and rear wheels generally at the four corners of the trailer.

### SUMMARY

The present disclosure provides for, in various features, an adjustable wheelbase system including: guide tracks configured to be mounted to a vehicle; a front support assembly configured to be attached to, and move along, the guide tracks; a front motor system mounted to the front support assembly and configured to rotate front wheels of the vehicle; a rear support assembly configured to be attached to, and move along, the guide tracks; a rear motor system mounted to the rear support assembly and configured to rotate rear wheels of the vehicle; a battery system configured to power the front motor system and the rear motor system; and a controller. The controller is configured to: control the front motor system to rotate the front wheels to move the front support assembly, and the front wheels in cooperation therewith, along the guide tracks between a front outboard position and a front inboard position; and control the rear motor system to rotate the rear wheels to move the rear support assembly, and the rear wheels in cooperation therewith, along the guide tracks between a rear outboard position and a rear inboard position.

In further features, the guide tracks include a pair of front guide tracks and a pair of rear guide tracks, the front support assembly mounted to the pair of front guide tracks and the rear support assembly mounted to the pair of rear guide tracks.

In further features, the front motor system includes a first front motor configured to rotate a first front wheel and a second front motor configured to rotate a second front wheel.

In further features, the rear motor system includes a first rear motor configured to rotate a first rear wheel and a second rear motor configured to rotate a second rear wheel.

In further features, the battery system includes a front battery configured to power the front motor system and a rear battery configured to power the rear motor system, the front battery is mounted to the front support assembly and the rear battery is mounted to the rear support assembly.

In further features, controller is configured to be mounted to the vehicle.

In further features, the controller includes a transmitter and is configured for use apart from the vehicle.

In further features, the front support assembly includes front bearing blocks seated within the guide tracks and the rear support assembly includes rear bearing blocks seated within the guide tracks.

In further features, the front motor system is in cooperation with the front wheels by way of front suspension arms including front transfer cases, and the rear motor system is in cooperation with the rear wheels by way of rear suspension arms including rear transfer cases.

In further features, the controller is further configured to operate the front motor system to rotate the front wheels in a first direction and operate the rear motor system to rotate the rear wheels in a second direction that is opposite to the first direction to move the front wheels between the front outboard position and the front inboard position and move the rear wheels between the rear outboard position and the rear inboard position.

In further features, the vehicle is configured as a trailer; and the controller is configured to control the front motor system and control the rear motor system to rotate the front wheels and the rear wheels to maneuver the trailer independent of a tow vehicle.

In further features, the controller is further configured to: move the front wheels between the front outboard position and the front inboard position by operating the front motor system to rotate the front wheels and simultaneously operating the rear motor system to brake the rear wheels; and move the rear wheels between the rear outboard position and the rear inboard position by operating the rear motor system to rotate the rear wheels and simultaneously operating the front motor system to brake the front wheels.

The present disclosure further provides for, in various features, an adjustable wheelbase system including: guide tracks mounted to a vehicle; a front support assembly attached to the guide tracks and configured to move along the guide tracks; a first front motor mounted to the front support assembly and in cooperation with a first front wheel to rotate the first front wheel; a second front motor mounted to the front support assembly and in cooperation with a second front wheel to rotate the second front wheel; a front battery mounted to the front support assembly and configured to power the first front motor and the second front motor; a rear support assembly attached to the guide tracks and configured to move along the guide tracks; a first rear motor mounted to the rear support assembly and in cooperation with a first rear wheel to rotate the first rear wheel; a second rear motor mounted to the rear support assembly and in cooperation with a second rear wheel to rotate the second rear wheel; a rear battery mounted to the rear support assembly and configured to power the first rear motor and the second rear motor; and a controller. The controller is configured to: control the first front motor to rotate the first front wheel and control the second front motor to rotate the second front wheel to move the front support assembly, and both the first front wheel and the second front wheel in cooperation therewith, along the guide tracks between a front outboard position and a front inboard position; and control the first rear motor to rotate the first rear wheel and control the second front motor to rotate the second rear wheel to move the rear support assembly, and both the first rear wheel and the second rear wheel in cooperation therewith, along the guide tracks between a rear outboard position and a rear inboard position.

In further features, the controller is mounted to the vehicle, the adjustable wheelbase system further including a remote control unit apart from the vehicle configured to operate the controller.

In further features, the controller is configured to control the first front motor, the second front motor, the first rear motor, and the second rear motor to operate each one of the first front wheel, the second front wheel, the first rear wheel, and the second rear wheel to drive the vehicle forward or rearward.

In further features, the vehicle is a trailer configured to be towed by a tow vehicle.

In further features, the controller is configured to: move the first front wheel and the second front wheel between the front outboard position and the front inboard position by operating the first front motor and the second front motor to rotate the first front wheel and the second front wheel, and simultaneously operating the first rear motor and the second rear motor to brake the first rear wheel and the second rear wheel; and move the first rear wheel and the second rear wheel between the front outboard position and the front inboard position by operating the first rear motor and the second rear motor to rotate the first rear wheel and the second rear wheel, and simultaneously operating the first front motor and the second front motor to brake the first front wheel and the second front wheel.

The present disclosure further provides for, in various features, an adjustable wheelbase system of a trailer. The system includes: guide tracks mounted to the trailer; a front support assembly attached to, and configured to move along, the guide tracks; a front motor system mounted to the front support assembly and in cooperation with front wheels of the trailer to rotate the front wheels; a front battery mounted to the front support assembly and configured to power the front motor system; a rear support assembly attached to, and configured to move along, the guide tracks; a rear motor system mounted to the rear support assembly and in cooperation with rear wheels of the trailer to rotate the rear wheels; a rear battery mounted to the rear support assembly and configured to power the rear motor system; and a controller. The controller is configured to: control the front motor system to rotate the front wheels to move the front support assembly, and the front wheels in cooperation therewith, along the guide tracks between a front outboard position and a front inboard position; and control the rear motor system to rotate the rear wheels to move the rear support assembly, and the rear wheels in cooperation therewith, along the guide tracks between a rear outboard position and a rear inboard position.

In further features, the controller is further configured to operate the front motor system to rotate the front wheels in a first direction and operate the rear motor system to rotate the rear wheels in a second direction that is opposite to the first direction to move the front wheels between the front outboard position and the front inboard position and move the rear wheels between the rear outboard position and the rear inboard position.

In further features, the controller is configured to control the front motor system and the rear motor system to operate each one of the front wheels and the rear wheels to drive the trailer forward or rearward; and the controller is mounted to the trailer, the adjustable wheelbase system further including a remote control unit apart from the trailer configured to operate the controller.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle including an adjustable wheelbase system in accordance with the present disclosure with the wheels in an outboard configuration;

FIG. 2 is a perspective view of the vehicle including the adjustable wheelbase system of the present disclosure with the wheels in an inboard configuration;

FIG. 3 is a plan view of the adjustable wheelbase system of the present disclosure with the wheels in the outboard configuration; and

FIG. 4 is a plan view of the adjustable wheelbase system of the present disclosure with the wheels in the inboard configuration.

In the drawings, reference numbers may be reused to identify similar and/or identical elements.

### DETAILED DESCRIPTION

The present disclosure includes an adjustable wheelbase system. The system is configured for use with any suitable vehicle, such as any suitable road vehicle. Suitable road vehicles include trailers configured to be towed by a tow vehicle. The adjustable wheelbase system may be configured for non-vehicular use as well.

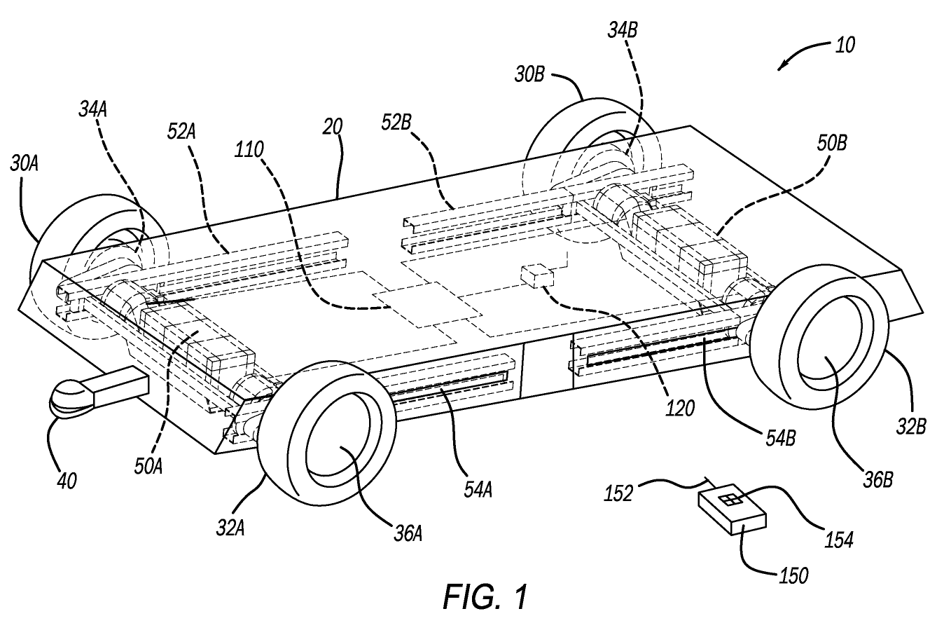

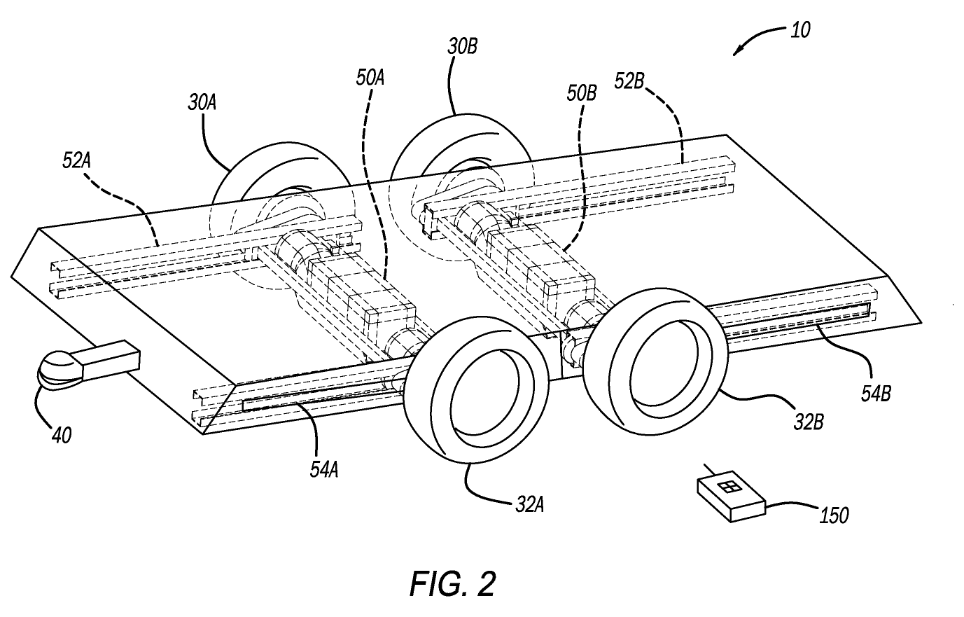

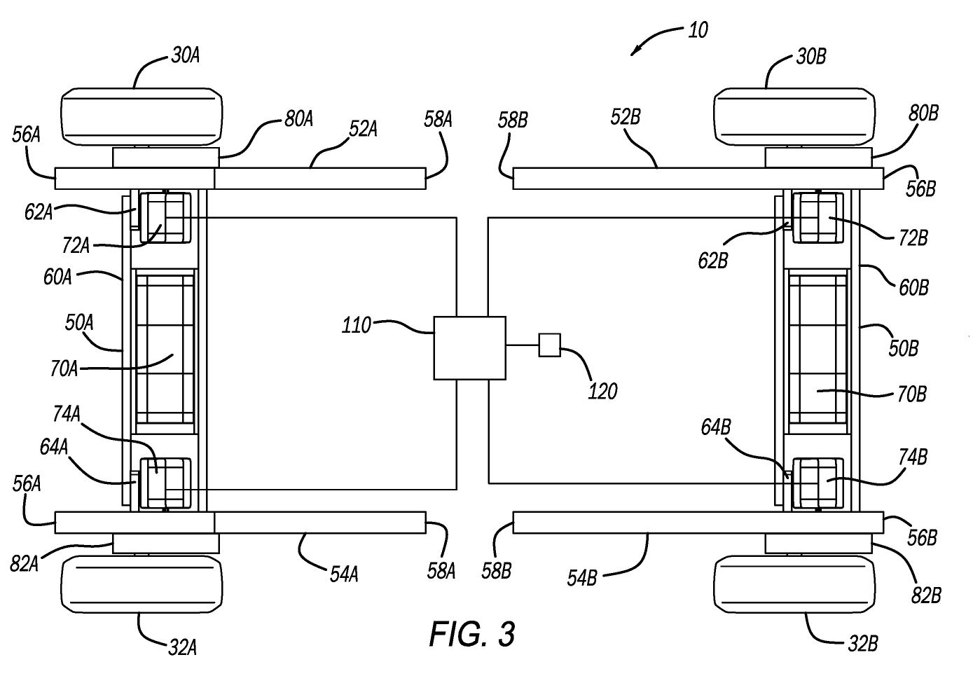

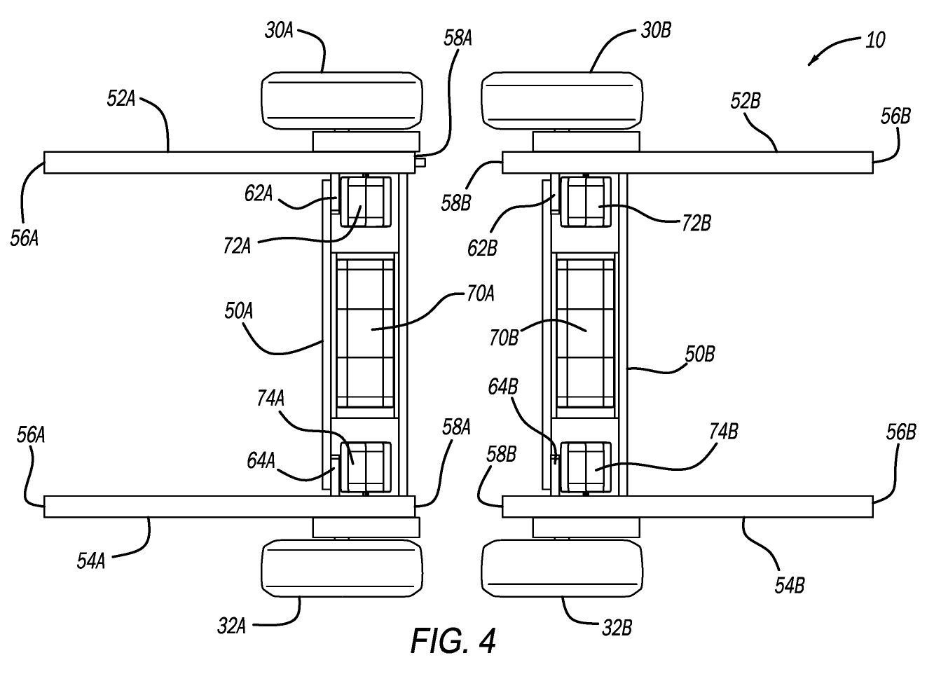

The adjustable wheelbase system is generally configured to move front and rear wheels between an outboard configuration (FIGS. 1 and 3) and an inboard configuration (FIGS. 2 and 4). In the outboard configuration, the front and rear wheels are generally at four corners of the vehicle. In the inboard configuration, the front and rear wheels are shifted inboard to a middle area of the vehicle.

The inboard configuration is particularly suitable for travel of the vehicle at relatively high speeds when being towed by a tow vehicle, such as a car or truck, to increase maneuverability, combat “fishtailing,” and provide appropriate weight distribution of load versus tongue weight, for example. In the outboard configuration, the front and rear wheels make the vehicle relatively more stable and maneuverable, particularly over off-road terrain.

The vehicle may be configured as an electric vehicle, which may be driven on its own apart from a tow vehicle. With the wheels in the outboard configuration, the vehicle may be operated under its own power over varied terrain. The vehicle may be operated by an onboard driver, remotely by an operator using a remote control unit in communication with an onboard controller of the vehicle, or by any suitable autonomous driving system.

FIGS. 1-4 illustrate an exemplary adjustable wheelbase system 10 in accordance with the present disclosure. The system 10 is configured for use with any suitable vehicle, such as any suitable trailer configured to be towed by a car, truck, or other tow vehicle. FIGS. 1-4 illustrate the vehicle configured as a trailer 20. The system 10 may be configured for any suitable non-vehicular use as well.

In the examples illustrated, the trailer 20 includes four wheels: a first front wheel 30A, a second front wheel 32A, a first rear wheel 30B, and a second rear wheel 32B. While four wheels are illustrated, the trailer 20 may be configured to include any other suitable number of wheels. For example, the trailer 20 may include more than two front wheels and/or more than two rear wheels. Additional front wheels may be configured to move inboard and outboard with the front wheels 30A, 32A, and additional rear wheels may be configured to move inboard and outboard with the rear wheels 30B, 32B. The trailer 20 may include less than two front wheels 30A, 32A and/or may include less than two rear wheels 30B, 32B.

The first front wheel 30A is mounted to a first front hub 34A. The second front wheel 32A is mounted to a second front hub 36A. The first rear wheel 30B is mounted to a first rear hub 34B. And the second rear wheel 32B is mounted to a second rear hub 36B. The trailer 20 further includes a hitch 40, which is configured to be coupled to any suitable tow vehicle.

The trailer 20 further includes a front wheel assembly 50A and a rear wheel assembly 50B, which are each mounted to a guide track system of the trailer 20. The front wheel assembly 50A and the rear wheel assembly 50B are movable with the wheels along the guide track system between the outboard configuration of FIGS. 1 and 3 and the inboard configuration of FIGS. 2 and 4. The guide track system is on opposite sides of the trailer 20. In the example illustrated, the guide track system includes a first front guide track 52A, a second front guide track 54A, a first rear guide track 52B, and a second rear guide track 54B.

With particular reference to FIG. 3, the first front guide track 52A and the second front guide track 54A each include an outer end 56A and an inner end 58A. The first rear guide track 52B and the second rear guide track 54B each include an outer end 56B and an inner end 58A. In some applications, the first front guide track 52A and the first rear guide track 52B may be a single guide track extending along the length of the trailer 20. Similarly, the second front guide track 54A and the second rear guide track 54B may be a single guide track extending along the length of the trailer.

The front wheel assembly 50A will now be described in further detail. The front wheel assembly 50A is the same as, or substantially similar to, the rear wheel assembly 50B. Thus, features of the front wheel assembly 50A and the rear wheel assembly 50B that are the same or similar are identified in the drawings using the same reference numbers, but reference numbers of the front wheel assembly 50A include the letter “A” and reference numbers of the rear wheel assembly 50B include the letter “B.” The description of the front wheel assembly 50A also applies to describe the rear wheel assembly 50B (and vice versa).

The front wheel assembly 50A includes a front support assembly 60A, which generally includes a cross member with a first front bearing block 62A and a second front bearing block 64A at opposite sides of the front support assembly 60A. The first front bearing block 62A is in cooperation with the first front guide track 52A, and the second front bearing block 64A is in cooperate with the second front guide track 54A to allow the front wheel assembly 50A to slide along the first front guide track 52A and the second front guide track 54A. Similarly, the rear wheel assembly 50B includes a rear support assembly 60B with a first rear bearing block 62B in cooperation with the first rear guide track 52B and a second rear bearing block 64B in cooperation with the second rear guide track 54B.

The front wheel assembly 50A further includes a front battery 70A, which is configured to power a first front motor 72A and a second front motor 74A. The first motor 72A and the second motor 74A are mounted to the front support assembly 60A. The front battery 70A is illustrated as also mounted to the front support assembly 60A, but the front battery 70A may alternatively mounted apart from the front support assembly 60A to any other portion of the trailer 20.

The first front motor 72A is in cooperation with the first front wheel 30A (and the first front hub 34A) and configured to rotate and brake the first front wheel 30A. The second front motor 74A is in cooperation with the second front wheel 32A (and the second front hub 36A) and configured to rotate and brake the second front wheel 30A. Similar to the front support assembly 60A, the rear support assembly 60B includes a rear battery 70B, a first rear motor 72B, and a second rear motor 74B for rotating and braking the first rear wheel 30B and the second rear wheel 32B. Although each one of the wheels is illustrated as being driven and braked by a separate electric motor, the front wheel assembly 50A may be configured to include a single motor for driving and braking both the first front wheel 30A and the second front wheel 32B. And the rear wheel assembly 50B may be configured to include a single motor for driving and braking both the first rear wheel 30B and the second rear wheel 32B.

The first front motor 72A is connected to the first front hub 34A by way of a first front suspension arm 80A, and the second front motor 74A is connected to the second front hub 36A by way of a second front suspension arm 82A. Similarly, the first rear motor 72B is connected to the first rear hub 34B by way of a first rear suspension arm 80B, and the second rear motor 74B is connected to the second rear hub 36B by way of a second rear suspension arm 82B. Each one of the suspension arms 80A, 82A, 80B, and 82B includes a power transfer case for managing transfer of power from each of the motors to each of the wheels.

The adjustable wheelbase system further includes a controller 110, which is configured to be mounted to the trailer 20. The controller 110 is in cooperation with, and configured to control, each of the first front motor 72A, the second front motor 74A, the first rear motor 72B, and the second rear motor 74B. The controller 110 may include any suitable user interface for accepting inputs to control the motors, as described herein. The controller 110 may be in further cooperation with any suitable transmitter/receiver 120, which is configured to communication with a remote controller 150 (FIG. 1). The remote controller 150 includes a transmitter/receiver 152 and any suitable user interface 154. The remote controller 150 is configured to control the first front motor 72A, the second front motor 74A, the first rear motor 72B, and the second rear motor 74B to move the front wheel assembly 50A and the rear wheel assembly 50B between the outboard configuration and the inboard configuration, and to generally drive the trailer 20.

To move the front wheel assembly 50A from the outboard configuration of FIGS. 1 and 3 to the inboard configuration of FIGS. 2 and 4, the controller 110 is configured to operate the first and second front motors 72A, 74A to rotate the first and second front wheels 30A, 32A clockwise, which will cause the front wheel assembly 50A to slide inward to a general center of the trailer 20. To move the rear wheel assembly 50B from the outboard position of FIGS. 1 and 3 to the inboard position of FIGS. 2 and 4, the controller 110 is configured to operate the first and second rear motors 72B, 74B to rotate the first and second rear wheels 30B, 32B counterclockwise, which will cause the rear wheel assembly 50B to slide inward to the general center of the trailer 20. The controller 110 is configured to move the front wheel assembly 50A and the rear wheel assembly 50B from the inboard configuration to the outboard configuration by reversing this operation.

The controller 110 may be configured to move the front wheel assembly 50A and the rear wheel assembly 50B simultaneously. Alternatively, the controller 110 may operate the first and second front motors 72A, 74A to rotate the first and second front wheels 30A, 32A while simultaneously braking the first and second rear motors 72B, 74B and the first and second rear wheels 30B, 32B. Similarly, the controller 110 may operate the first and second rear motors 72B, 74B to rotate the first and second rear wheels 30B, 32B while simultaneously braking the first and second front motors 72A, 74A and the first and second front wheels 30A, 32A.

Operation of the controller 110 to move the front wheel assembly 50A and the rear wheel assembly 50B between the inboard and outboard configurations may be controlled by way of a user interface onboard the trailer 20. Alternatively, a user may input commands to the controller 110 by way of the remote controller 150 to move the front wheel assembly 50A and the rear wheel assembly 50B between the inboard and outboard configurations. Still further, the controller 110 may be configured to automatically configure the trailer 20 in the inboard configuration or the outboard configuration based on the speed of the vehicle. For example, when the trailer 20 is traveling above a predetermined speed (such as 10mph, for example), the controller 110 may be configured to automatically arrange the front wheel assembly 50A and the rear wheel assembly 50B in the inboard configuration of FIGS. 2 and 4 to enhance stability of the trailer 20. When the trailer 20 is traveling below the predetermined speed, the controller 110 may be configured to automatically arrange the front wheel assembly 50A and the rear wheel assembly 50B in the outboard configuration of FIGS. 1 and 3 to enhance maneuverability of the trailer 20 and stability over uneven terrain.

The trailer 20 may be driven on its own (such as in a self-drive mode, for example) apart from any tow vehicle. For example, the controller 110 may be configured to operate all of the motors 72A, 74A, 72B, and 74B to rotate all of the wheels 30A, 32A, 30B, and 32B in the same direction, such as forward to move the trailer 20 forward or rearward to move the trailer 20 backwards. The front wheels 30A, 32A and/or the rear wheels 30B, 30B are configured to be rotated in any suitable manner to steer the trailer 20 when operated in this self-drive mode. The trailer 20 may be driven manually by a driver onboard the trailer 20 using a user interface of the controller 110, driven remotely by way of the remote controller 150, or be driven using any suitable autonomous driving system. In the self-drive mode, the front wheel assembly 50A and the rear wheel assembly 50B will typically be oriented in the outboard configuration of FIGS. 1 and 3 to enhance stability and maneuverability.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An adjustable wheelbase system comprising:
guide tracks configured to be mounted to a vehicle;
a front support assembly configured to be attached to, and move along, the guide tracks;
a front motor system mounted to the front support assembly and configured to rotate front wheels of the vehicle;
a rear support assembly configured to be attached to, and move along, the guide tracks;
a rear motor system mounted to the rear support assembly and configured to rotate rear wheels of the vehicle;
a battery system configured to power the front motor system and the rear motor system; and
a controller configured to:
control the front motor system to rotate the front wheels to move the front support assembly, and the front wheels in cooperation therewith, along the guide tracks between a front outboard position and a front inboard position; and
control the rear motor system to rotate the rear wheels to move the rear support assembly, and the rear wheels in cooperation therewith, along the guide tracks between a rear outboard position and a rear inboard position.

2. The adjustable wheelbase system of claim 1, wherein the guide tracks include a pair of front guide tracks and a pair of rear guide tracks, the front support assembly mounted to the pair of front guide tracks and the rear support assembly mounted to the pair of rear guide tracks.

3. The adjustable wheelbase system of claim 1, wherein the front motor system includes a first front motor configured to rotate a first front wheel and a second front motor configured to rotate a second front wheel.

4. The adjustable wheelbase system of claim 1, wherein the rear motor system includes a first rear motor configured to rotate a first rear wheel and a second rear motor configured to rotate a second rear wheel.

5. The adjustable wheelbase system of claim 1, wherein the battery system includes a front battery configured to power the front motor system and a rear battery configured to power the rear motor system, the front battery is mounted to the front support assembly and the rear battery is mounted to the rear support assembly.

6. The adjustable wheelbase system of claim 1, wherein the controller is configured to be mounted to the vehicle.

7. The adjustable wheelbase system of claim 1, wherein the controller includes a transmitter and is configured for use apart from the vehicle.

8. The adjustable wheelbase system of claim 1, wherein the front support assembly includes front bearing blocks seated within the guide tracks and the rear support assembly includes rear bearing blocks seated within the guide tracks.

9. The adjustable wheelbase system of claim 1, wherein the front motor system is in cooperation with the front wheels by way of front suspension arms including front transfer cases, and the rear motor system is in cooperation with the rear wheels by way of rear suspension arms including rear transfer cases.

10. The adjustable wheelbase system of claim 1, wherein the controller is further configured to operate the front motor system to rotate the front wheels in a first direction and operate the rear motor system to rotate the rear wheels in a second direction that is opposite to the first direction to move the front wheels between the front outboard position and the front inboard position and move the rear wheels between the rear outboard position and the rear inboard position.

11. The adjustable wheelbase system of claim 1, wherein:
the vehicle is configured as a trailer; and
the controller is configured to control the front motor system and control the rear motor system to rotate the front wheels and the rear wheels to maneuver the trailer independent of a tow vehicle.

12. The adjustable wheelbase system of claim 1, wherein the controller is further configured to:
move the front wheels between the front outboard position and the front inboard position by operating the front motor system to rotate the front wheels and simultaneously operating the rear motor system to brake the rear wheels; and
move the rear wheels between the rear outboard position and the rear inboard position by operating the rear motor system to rotate the rear wheels and simultaneously operating the front motor system to brake the front wheels.

13. An adjustable wheelbase system comprising:
guide tracks mounted to a vehicle;
a front support assembly attached to the guide tracks and configured to move along the guide tracks;
a first front motor mounted to the front support assembly and in cooperation with a first front wheel to rotate the first front wheel;
a second front motor mounted to the front support assembly and in cooperation with a second front wheel to rotate the second front wheel;
a front battery mounted to the front support assembly and configured to power the first front motor and the second front motor;
a rear support assembly attached to the guide tracks and configured to move along the guide tracks;
a first rear motor mounted to the rear support assembly and in cooperation with a first rear wheel to rotate the first rear wheel;
a second rear motor mounted to the rear support assembly and in cooperation with a second rear wheel to rotate the second rear wheel;
a rear battery mounted to the rear support assembly and configured to power the first rear motor and the second rear motor; and
a controller configured to:
control the first front motor to rotate the first front wheel and control the second front motor to rotate the second front wheel to move the front support assembly, and both the first front wheel and the second front wheel in cooperation therewith, along the guide tracks between a front outboard position and a front inboard position; and
control the first rear motor to rotate the first rear wheel and control the second front motor to rotate the second rear wheel to move the rear support assembly, and both the first rear wheel and the second rear wheel in cooperation therewith, along the guide tracks between a rear outboard position and a rear inboard position.

14. The adjustable wheelbase system of claim 13, wherein the controller is mounted to the vehicle, the adjustable wheelbase system further including a remote control unit apart from the vehicle configured to operate the controller.

15. The adjustable wheelbase system of claim 13, wherein the controller is configured to control the first front motor, the second front motor, the first rear motor, and the second rear motor to operate each one of the first front wheel, the second front wheel, the first rear wheel, and the second rear wheel to drive the vehicle forward or rearward.

16. The adjustable wheelbase system of claim 15, wherein the vehicle is a trailer configured to be towed by a tow vehicle.

17. The adjustable wheelbase system of claim 16, wherein the controller is further configured to:
move the first front wheel and the second front wheel between the front outboard position and the front inboard position by operating the first front motor and the second front motor to rotate the first front wheel and the second front wheel, and simultaneously operating the first rear motor and the second rear motor to brake the first rear wheel and the second rear wheel; and
move the first rear wheel and the second rear wheel between the front outboard position and the front inboard position by operating the first rear motor and the second rear motor to rotate the first rear wheel and the second rear wheel, and simultaneously operating the first front motor and the second front motor to brake the first front wheel and the second front wheel.

18. An adjustable wheelbase system of a trailer, the adjustable wheelbase system comprising:
guide tracks mounted to the trailer;
a front support assembly attached to, and configured to move along, the guide tracks;
a front motor system mounted to the front support assembly and in cooperation with front wheels of the trailer to rotate the front wheels;
a front battery mounted to the front support assembly and configured to power the front motor system;
a rear support assembly attached to, and configured to move along, the guide tracks;
a rear motor system mounted to the rear support assembly and in cooperation with rear wheels of the trailer to rotate the rear wheels;
a rear battery mounted to the rear support assembly and configured to power the rear motor system; and
a controller configured to:
control the front motor system to rotate the front wheels to move the front support assembly, and the front wheels in cooperation therewith, along the guide tracks between a front outboard position and a front inboard position; and
control the rear motor system to rotate the rear wheels to move the rear support assembly, and the rear wheels in cooperation therewith, along the guide tracks between a rear outboard position and a rear inboard position.

19. The adjustable wheelbase system of claim 18, wherein the controller is further configured to operate the front motor system to rotate the front wheels in a first direction and operate the rear motor system to rotate the rear wheels in a second direction that is opposite to the first direction to move the front wheels between the front outboard position and the front inboard position and move the rear wheels between the rear outboard position and the rear inboard position.

20. The adjustable wheelbase system of claim 19, wherein:
the controller is configured to control the front motor system and the rear motor system to operate each one of the front wheels and the rear wheels to drive the trailer forward or rearward; and
the controller is mounted to the trailer, the adjustable wheelbase system further including a remote control unit apart from the trailer configured to operate the controller.
